(19) United States
(12) Patent Application Publication
(10) Pub. No.: US 2009/0075514 A1
(43) Pub. Date: Mar. 19, 2009

(54) TEST SOCKET

(76) Inventors: Hitoshi Saitoh, Sakurai-shi (JP); Makoto Tsuji, Tondabayashi-shi (JP)

Correspondence Address: NIXON & VANDERHYE, PC, 901 NORTH GLEBE ROAD, 11TH FLOOR, ARLINGTON, VA, 22203, US

(21) Appl. No.: 12/204,179

(22) Filed: Sep. 4, 2008

(30) Foreign Application Priority Data
Sep. 14, 2007 (JP) 2007-238827

(51) Int. Cl. H01R 13/64

(52) U.S. Cl. 439/374

(57) ABSTRACT

Provided is a test socket capable of being used more flexibly for solid-state image pickup devices of different shapes and of performing locating of the solid-state image pickup devices more precisely. The test socket houses a tested device which is a solid-state image pickup device while a test is being performed. The test socket comprises: first locating means for locating the tested device in an X direction parallel to a ceiling plane of the tested device in a housed state; urging means for urging the first locating means in a Z direction perpendicular to the ceiling plane of the tested device in the housed state; and position setting means for setting an upper limit of movement in the Z direction of the first locating means caused by the urging means to set a position in the Z direction of the first locating means relative to the tested device.

### CROSS REFERENCE TO RELATED APPLICATION

This Nonprovlsional application claims priority under 35 U.S.C. §119(a) on Patent Application No. 2007-238827 filed in Japan on Sep. 14, 2007, the entire contents of which are hereby incorporated by reference.

### BACKGROUND OF THE INVENTION

1. Field of the Invention

The present invention relates to a test socket including locating means for locating a solid-state image pickup device fitted therein.

The present invention relates to a socket configured to locate a solid-state image pickup device inserted therein so as to enable optical centering at all times, and hence being adaptable to solid-state image pickup devices of different sizes.

2. Description of the Related Art

Recently, with the remarkable advancement in performance of image pickup instruments using solid-state image pickup devices, such as cellular phones with a camera function and digital still cameras, the solid-state image pickup devices have also become increasingly advanced in performance, e.g., having a mega number of pixels and a wide angle of view. In addition, some solid-state image pickup devices are densely packed by mounting a circuit board, such as a flexible printed board or a rigid board, implementing a camera driving circuit thereon.

In a manufacturing process of solid-state image pickup devices, various tests are conventionally performed to screen out defective products. The test of a solid-state image pickup device is usually performed with the solid-state image pickup device of the test target being fitted in a test socket provided in a tester for electrical testing, characteristic evaluation, or the like.

The structure of a test socket for a solid-state image pickup device is briefly described below with reference to FIG. 7. FIG. 7 illustrates an exemplary schematic configuration of a conventional test socket for a solid-state image pickup device, in particular, of a test socket 100 for a solid-state image pickup device mounted with a circuit board.

As shown in FIG. 7, the test socket 100 includes a base 110 and a cover 120 to house a solid-state image pickup device. The base 110 is provided with a first recess 111 that conforms to the lower shape of the main body including the circuit board of the solid-state image pickup device. The cover 120 is provided, at a position corresponding to the position of the first recess 111, with a second recess 121 that conforms to the upper shape of the main body including the circuit board of the solid-state image pickup device. The first recess 111 provided in the base 110 and the second recess 121 provided in the cover 120 jointly house the solid-state image pickup device. A contact portion including a plurality of contact pins is provided on the bottom surface of the first recess 111 in the base 110 so as to establish electrical connection with terminals of the solid-state image pickup device. It should be noted that the first recess 111 in the base 110 and the second recess 121 in the cover 120 are usually provided with some play to allow the solid-state image pickup device to be smoothly fitted/released.

In order to perform a test in a favorable manner for a solid-state image pickup device, especially for a high-performance solid-state image pickup device as mentioned above, the focal point and angle of view of the solid-state image pickup device should be adjusted to an optical center as accurately as possible. As described above, however, since the first recess 111 in the base 110 and the second recess 121 in the cover 120 of the test socket 100 are usually provided with some play, the solid-state image pickup device should be located as precisely as possible in order to perform the test with a satisfactory degree of accuracy.

Exemplary techniques for locating a solid-state image pickup device in a test socket include one using a test socket having, as locating means for locating and fixing the solid-state image pickup device in a direction (a first direction) parallel to the ceiling plane of the solid-state image pickup device in a housed state, movable chucks to urge toward the center each of predetermined two diagonal corners out of the corners of the solid-state image pickup device (see, e.g., Japanese Unexamined Patent Publication No. 2007-109534).

In a case, however, where, e.g., a test is performed using a conventional test socket on a solid-state image pickup device mounted with a circuit board, and the circuit board is mounted at such a position that locating means of the test socket contacts the solid-state image pickup device, it is sometimes difficult to locate the solid-state image pickup device in fitting the solid-state image pickup device into the test socket, because of, e.g., the contact between the locating means and the circuit board. In such a case, there arises a need to fabricate a test socket dedicated for each of the shapes of solid-state image pickup devices so as to accommodate different shapes of the solid-state image pickup devices.

### SUMMARY OF THE INVENTION

The present invention was made in view of the foregoing problems, and it is an object of the present invention to provide a test socket capable of being used more flexibly for solid-state image pickup devices of different shapes and of performing locating of the solid-state image pickup devices more precisely.

According to a first feature, a test socket according to the present invention for achieving the above object relates to a test socket for housing a tested device while a test is being performed, the tested device being a solid-state image pickup device, the test socket comprising: first locating means for locating the tested device in a first direction parallel to a ceiling plane of the tested device in the housed state; urging means for urging the first locating means in a second direction perpendicular to the ceiling plane of the tested device in the housed state; and position setting means for setting an upper limit of the movement in the second direction of the first locating means caused by the urging means to set a position in the second direction of the first locating means relative to the tested device.

According to a second feature, in the test socket according to the above feature of the present invention, the first locating means may comprise: a first fixing portion that is disposed on the test socket fixedly with respect to the first direction and supports a first corner which is one of corners on a diagonal of the tested device; and a second fixing portion that is provided in a slidable manner in a direction parallel to the diagonal of the tested device and urges, toward the first fixing portion, a second corner which is the other of the corners on the diagonal of the tested device.

According to a third feature, in the test socket according to any of the above features of the present invention, the urging means and a contact portion including a plurality of contact terminals to establish electrical connection with terminals of the tested device may be provided at a side opposite in direction to the second direction with respect to the first locating means, and the test socket may further comprise second locating means for urging the tested device in a direction opposite to the second direction from a side along the second direction with respect to the first locating means to fix a position of the ceiling plane of the tested device to a predetermined ceiling position.

According to a fourth feature, in the test socket according to the above feature of the present invention, the contact terminals may be arranged in a matrix in the contact portion.

Since the test socket according to the above-described features includes the urging means for urging the first locating means in the second direction and the position setting means for setting the upper limit of the movement in the second direction of the first locating means caused by the urging means, it becomes possible to control the position in the second direction of the first locating means as appropriate relative to the solid-state image pickup device in the housed state. With this structure, in the case of, e.g., performing a test on a solid-state image pickup device mounted with a circuit board, the test socket according to the above-described features can set the position where the first locating means contacts the solid-state image pickup device to a position outside the circuit board mounting portion. Accordingly, the test socket according to the above-described features can be used for solid-state image pickup devices of different shapes more flexibly, hence allowing a solid-state image pickup device to be housed and fixed therein regardless of present or absence of a built-in circuit board.

Also, since the test socket according to the above-described features includes the first locating means for locating the solid-state image pickup device in the direction (the first direction) parallel to the ceiling plane of the solid-state image pickup device in the housed state, the locating in the first direction can be performed accurately. With this structure, the focal point and angle of view of a solid-state image pickup device can be adjusted more accurately to an optical center.

In the test socket according to the second feature, the first locating means may include the first fixing portion that supports and fixes the first corner of the solid-state image pickup device and the second fixing portion that urges the second corner of the solid-state image pickup device toward the first corner, the second corner being diagonally across the first corner; therefore, the first locating means can be provided in a simple structure, and the locating in the first direction can be carried out accurately.

The test socket according to the third feature may include the second locating means for urging the tested device from the side along the second direction of the first locating means in the direction opposite to the second direction, so as to fix the position of the ceiling plane of the tested device to a predetermined ceiling position; therefore, the locating in the second direction can be performed accurately.

The test socket according to the fourth feature may include the contact portion in which the contact terminals are arranged in a matrix; therefore, the same test socket can be used for the solid-state image pickup devices that have the same side-to-terminal distance and the same terminal interval. Accordingly, it becomes possible to cut costs involved in the test and reduce the time required for developing test sockets.

### BRIEF DESCRIPTION OF THE DRAWINGS

FIG. 1 is a top view showing an exemplary schematic configuration of an opened test socket according to the present invention;

FIGS. 2A and 2B are schematic views showing exemplary configurations of main portions of a base of the test socket according to the present invention;

FIG. 3 is a top view showing an exemplary schematic configuration of the base of the test socket according to the present invention with a tested device fixed therein;

FIG. 4 is a top view showing an exemplary schematic configuration of the base of the test socket according to the present invention, where the tested device can be fitted or released;

FIG. 5 is a top view showing an exemplary schematic configuration of a contact portion of the test socket according to the present invention;

FIG. 6 is an end view showing a configuration of a latch member for interlocking a cover with the base; and

FIG. 7 is a perspective view showing the schematic configuration of a conventional test socket for a solid-state image pickup device.

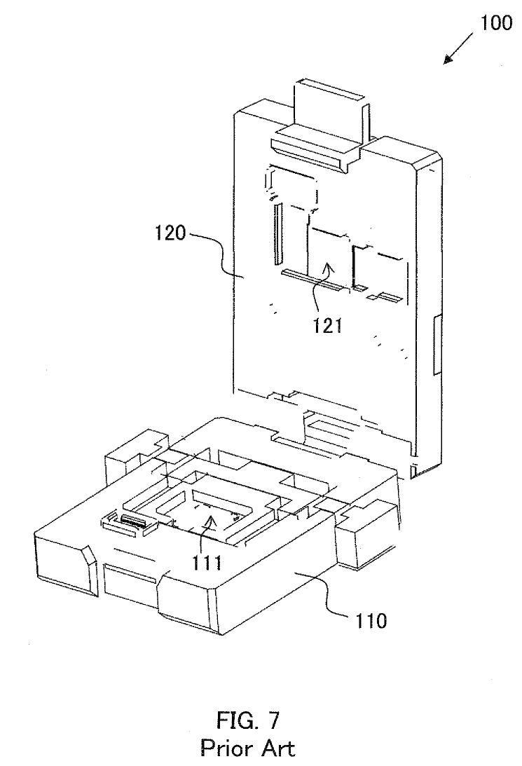

### DESCRIPTION OF THE PREFERRED EMBODIMENTS

Embodiments of a test socket according to the present invention are described below with reference to the drawings.

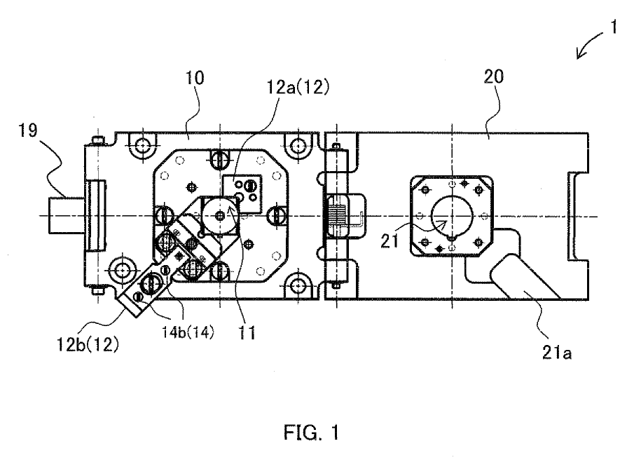

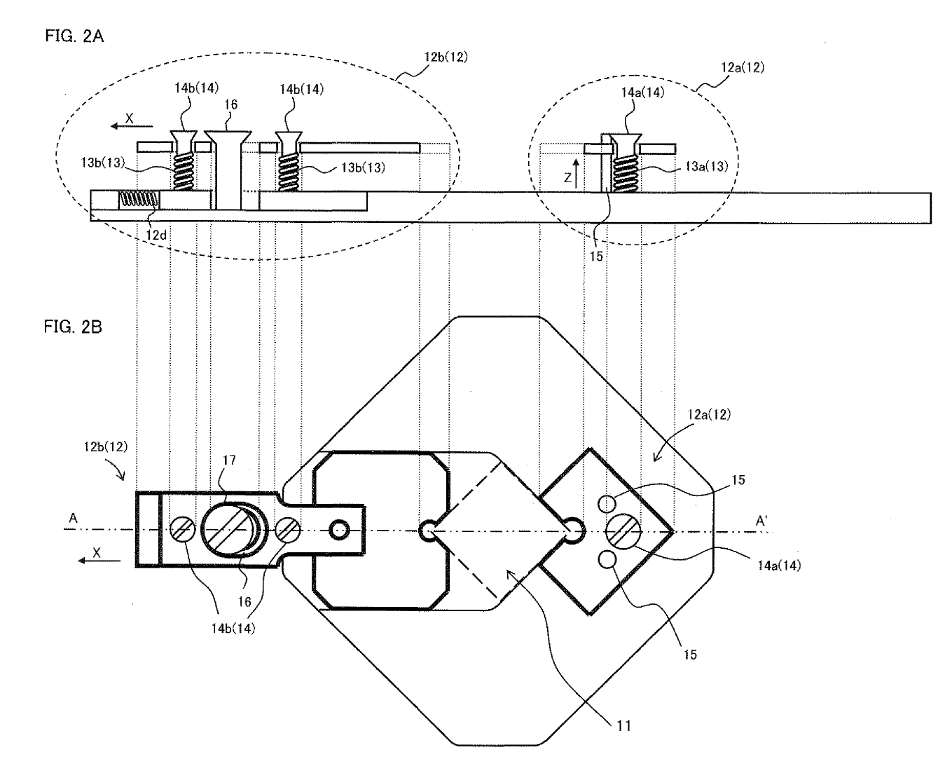

A structure of a test socket according to the present invention is described with reference to FIGS. 1 to 6. FIG. 1 shows an exemplary schematic configuration of an opened test socket 1 according to the present invention. FIGS. 2A and 2B show exemplary schematic configurations of main portions of a base 10 to be described later of the test socket 1 shown in FIG. 1, where FIG. 2A is a cross-sectional view taken along line A-A′ in FIG. 2B, and FIG. 2B is a top view of the base 10. It should be noted that the present embodiment is described on the assumption that the tested device to be housed in the test socket is a solid-state image pickup device that includes a circuit board in a lower portion of its main body and an image pickup portion on its ceiling plane.

As shown in FIG. 1, the test socket 1 includes the base 10 and a cover 20 that have an approximately rectangular solid shape. As in the conventional technique, the base 10 is provided with a first recess 11 that conforms to the lower shape of the main body including the circuit board of the tested device, whereas the cover 20 is provided, at a position corresponding to the first recess 11, with a second recess 21 that conforms to the upper shape of the main body including the circuit board of the tested device. The first recess 11 provided in the base 10 and the second recess 21 provided in the cover 20 jointly house the tested device. It should be noted that, as in the conventional technique, the first recess 11 in the base 10 and the second recess 21 in the cover 20 are provided with some play so as to allow the tested device to be smoothly fitted/released. Moreover, the test socket 1 includes a latch member 19 for interlocking the cover 20 with the base 10.

As shown in FIGS. 1, 2A, and 2B, the base 10 includes first locating means 12, urging means 13, and position setting means 14. The first locating means 12 locates the tested device in an X direction (corresponding to the first direction) parallel to the ceiling plane of the tested device in a housed state. The urging means 13 urges the first locating means 12 in a Z direction (corresponding to the second direction) perpendicular to the ceiling plane of the tested device in the housed state. The position setting means 14 sets an upper limit of the movement in the Z direction of the first locating means 12 caused by the urging means 13 and sets the position in the Z direction of the first locating means 12 relative to the tested device. It should be noted that the present embodiment is described on the assumption that the urging means 13 uses springs 13, and that the position setting means 14 uses screws 14.

More specifically, as shown in FIGS. 2A and 2B, the first locating means 12 of the base 10 includes first and second fixing portions 12a and 12b. The first fixing portion 12a is disposed on the test socket 1 fixedly with respect to the X direction and supports a first corner which is one of the corners on a diagonal of the tested device in a housed state. The second fixing portion 12b is provided in a slidable manner in a direction parallel to the diagonal AA′ (the X direction in the present embodiment) and urges a second corner which is the other of the corners on the diagonal toward the first fixing portion 12a.

As shown in FIGS. 2A and 2B, the first fixing portion 12a is constructed using an approximately L-shaped plate-like member with an approximately right-angled triangular cutout that fits the first corner of the tested device. The plate-like member includes a pair of openings that individually passes a pair of supports 15 in a slidable manner in the Z direction. The paired supports 15 are disposed in the respective openings in the plate-like member, so that the position of the first fixing portion 12a can be fixed in the X direction, and that the urging means 13 and the position setting means 14, as well as second locating means, can be moved in the Z direction, which will be described later.

As shown in FIGS. 2A and 2B, the plate-like member of the first fixing portion 12a includes an opening to pass a screw 14a serving as the position setting means 14 in a slidable manner in the Z direction. The screw 14a is passed through the opening in the plate-like member of the first fixing portion 12a, past a spring 13a serving as the urging means 13, and is partly fastened to the base 10. The plate-like member of the first fixing portion 12a is urged in the Z direction by the spring 13a disposed between the plate-like member of the first fixing portion 12a and the base (i.e., fitted at the side opposite in direction to the Z direction of the first locating means 12). While the test socket 1 is opened, the plate-like member of the first fixing portion 12a is fixed in contact with a thread of the screw 14a. That is, the fastening tightness of the screw 14a determines an upper limit of movement in the Z direction of the plate-like member of the first fixing portion 12a. The screw 14a may be fastened tightly to the base 10 to set the upper limit of the movement at a low position, whereas the screw 14a may be fastened loosely to the base 10 to set to upper limit of the movement at a high position.

As shown in FIGS. 2A and 2B, the second fixing portion 12b includes a plate-like member with an approximately right-angled triangular cutout 12c that fits the second corner of the tested device, as well as a spring 12d to urge the plate-like member in the X direction. The plate-like member includes an opening 17 to pass a support 16 therethrough. The opening 17 is approximately formed into a track so as to permit the plate-like member of the second fixing portion 12b to slide in the X and Z directions by disposing the support 16 in the opening 17.

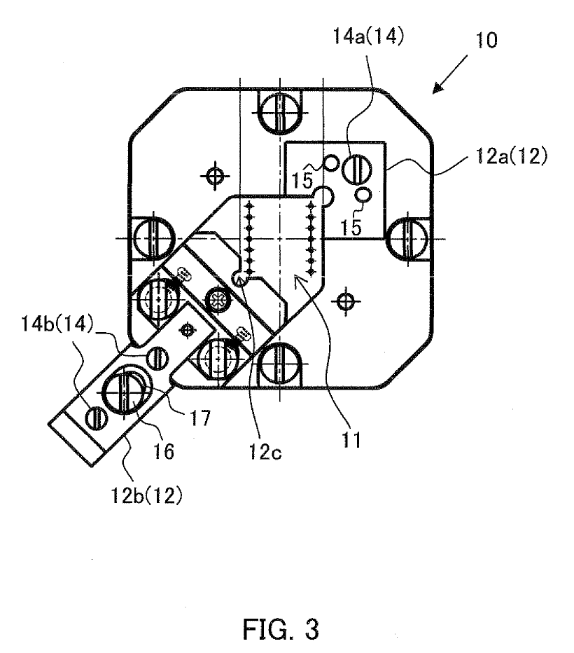

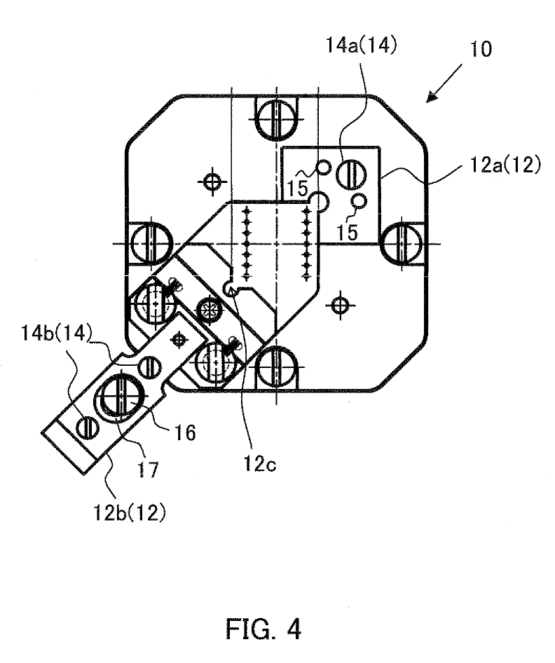

FIG. 3 shows a positional relationship between the second fixing portion 12b and the base 10 while the tested device can be fitted/released, whereas FIG. 4 shows a positional relationship between the second fixing portion 12b and the base 10 while the tested device is fixed. To fit the tested device in the test socket 1, the second fixing portion 12b is first moved in the X direction to bring the test socket 1 into the receivable state shown in FIG. 3, and the lower portion of the tested device is inserted into the first recess 11 of the base 10. The spring 12d urges the second fixing portion 12b in a direction opposite to the X direction, whereby the tested device is located in the X direction with its first and second corners held by the first and second fixing portions 12a and 12b. The tested device can be located accurately with its first corner being fixed at the same position, i.e., meeting the cutout of the first fixing portion 12a, at all times.

Further, as shown in FIGS. 2A and 2B, the plate-like member of the second fixing portion 12b includes a pair of openings to pass a pair of screws 14b serving as the position setting means 14 in a slidable manner in the Z direction. The screws 14b are passed through the respective openings in the plate-like member of the second fixing portion 12b, past springs 13b serving as the urging means 13, and are partly fastened to the base 10. The plate-like member of the second fixing portion 12b is urged in the Z direction by the springs 13b disposed between the plate-like member of the second fixing portion 12b and the base. While the test socket 1 is opened, the plate-like member of the second fixing portion 12b is fixed in contact with threads of the screws 14b. That is, the fastening tightness of the screws 14b determines an upper limit of the movement in the Z direction of the plate-like member of the second fixing portion 12b. The screws 14b may be fastened tightly to the base 10 to set the upper limit of the movement at a low position, whilst the screws 14b may be fastened loosely to the base 10 to set the upper limit of the movement at a high position.

It should be noted that the screw 14a for setting the upper limit of the movement in the Z direction of the first fixing portion 12a and the screws 14b for setting the upper limit of the movement in the Z direction of the second fixing portion 12b are desirably fastened to the base 10 such that the plate-like member of the first fixing portion 12a and the plate-like member of the second fixing portion 12b are set at an equal level; however, the present invention is not limited thereto, and the setting is performed appropriately in view of the thicknesses of the plate-like members, the mounting position of the circuit board in the tested device, and the like. Accordingly, the tested device can be fixed with the first and second fixing portions 12a and 12b being kept from contacting the circuit board and the like of the tested device.

The base 10 is provided at its bottom with a contact portion 18 including a plurality of contact terminals 18a (contact pins 18a) so as to establish electrical connection with terminals of the tested device. In the present embodiment, the contact terminals 18a are arranged in a matrix in the contact portion 18.

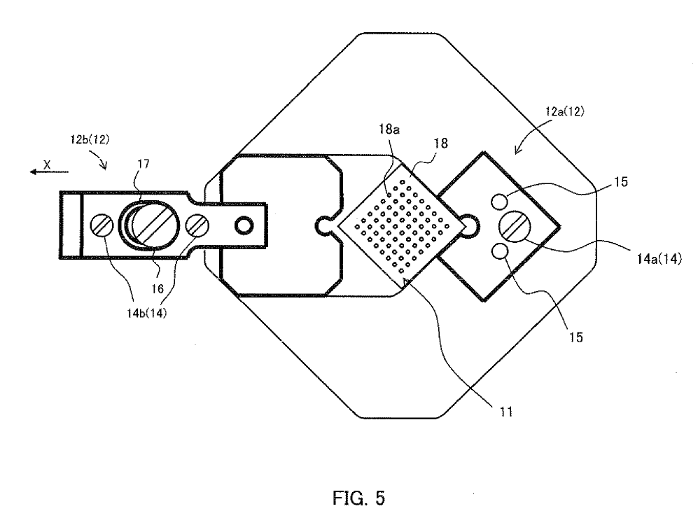

FIG. 5 shows an exemplary schematic configuration of the contact portion 18. As described above, the second fixing portion 12b is constructed to be slidable in the X direction in FIGS. 2A, 2B, and 5. Accordingly, the present invention is adaptable to, as shown in FIG. 5, solid-state image pickup devices that have the same end-to-terminal distance and the same terminal interval in tested devices thereof, and that are equal to or below the maximum size of the solid-state image pickup devices, which size is dependent on the number and arrangement of the contact terminals 18a of the contact portion 18.

The cover 20 to serve as the second locating means renders the test socket, with the tested device placed in the first recess 11 of the base 10, closed by interlocking with the base 10 through the latch member 19 to be described later, thereby urging the tested device in a direction opposite to the Z direction to fix the position of the ceiling plane of the tested device to a predetermined ceiling position. More specifically, in the present embodiment, the second recess 21 in the cover 20 is provided so as to contact the ceiling plane of the tested device, which allows the position in the Z direction of the image pickup portion provided on the ceiling plane of the tested device to be fixed at the same position relative to the cover 20 at all times.

Moreover, the cover 20 of the present invention includes a third recess 21a to ensure the movement of the second fixing portion 12b. The third recess 21a has a shape that conforms to the shape of the second fixing portion 12b.

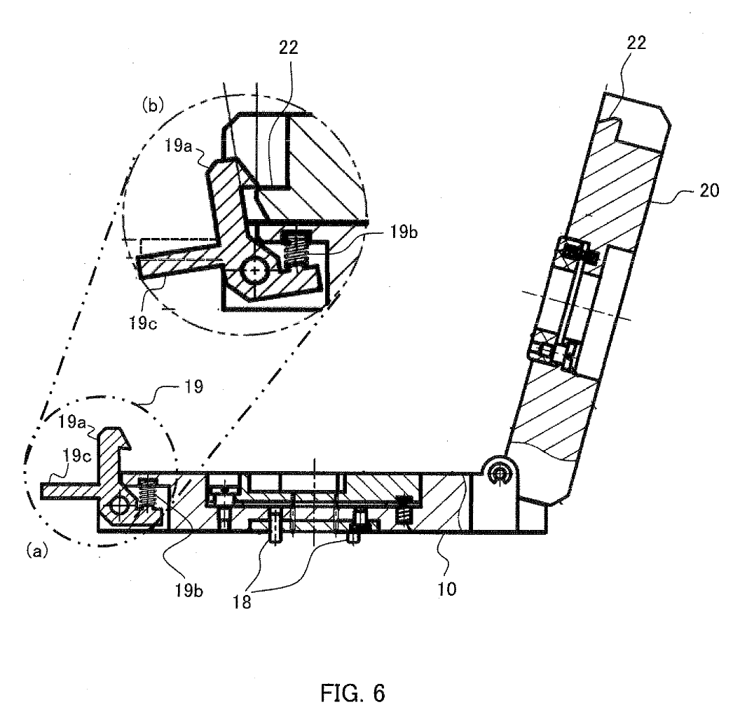

As shown in FIG. 6, the latch member 19 includes an interlocking portion 19a, a spring 19b, and a releasing portion 19c. The interlocking portion 19a of the latch member 19 is urged by the spring 19b toward the cover 20 to automatically interlock with an interlocking portion 22 of the cover 20 when the test socket 1 is closed. When the releasing portion 19c of the latch member 19 is pressed oppositely to the Z direction while the latch member 19 is interlocked, the cover 20 is released from the interlocking state. It should be noted that, in the present embodiment, as shown in FIG. 1, the base 10 and the cover 20 of the test socket 1 are urged in an opening direction, and thus the test socket will automatically be opened as shown in FIG. 1 upon release of the interlocking via the latch member 19.

### Other Embodiments

(1) The foregoing embodiment is described of a case in which the base 10 includes the first locating means 12, the urging means 13, and the position setting means 14; however, the present invention is not limited thereto, and the cover 20 may include all or part of these components.

(2) Although the foregoing embodiment is described on the assumption that the urging means 13 uses the springs 13 and the position setting means 14 uses the screws 14, the present invention is not limited thereto. The urging means 13 may be, e.g., an elastic member other than springs, a motor, or the like, and the position setting means 14 is constructed in accordance with the structure of the urging means 13.

(3) Although the foregoing embodiment is described based on an example where the tested device is a solid-state image pickup device mounted with a circuit board, the present invention is not limited thereto. The test socket according to the present invention is particularly useful for tested devices that are limited in area to be contacted by the first locating means 12. It should be noted that in a case of a solid-state image pickup device without a circuit board and the like, the position in the Z direction of the first locating means 12 can be selected so as to favorably fix the solid-state image pickup device in view of the structure of the device.

Although the present invention has been described in terms of the preferred embodiment, it will be appreciated that various modifications and alternations might be made by those skilled in the art without departing from the spirit and scope of the invention. The invention should therefore be measured in terms of the claims which follow.

What is claimed is:

1. A test socket for housing a tested device while a test is being performed, the tested device being a solid-state image pickup device, the test socket comprising:
first locating means for locating the tested device in a first direction parallel to a ceiling plane of the tested device in a housed state;
urging means for urging the first locating means in a second direction perpendicular to the ceiling plane of the tested device in the housed state; and
position setting means for setting an upper limit of movement in the second direction of the first locating means caused by the urging means to set a position in the second direction of the first locating means relative to the tested device.

2. The test socket according to claim 1, wherein
the first locating means comprises
a first fixing portion that is disposed on the test socket fixedly with respect to the first direction and supports a first corner which is one of corners on a diagonal of the tested device and
a second fixing portion that is provided in a slidable manner in a direction parallel to the diagonal of the tested device and urges, toward the first fixing portion, a second corner which is the other of the corners on the diagonal of the tested device.

3. The test socket according to claim 1, wherein
the urging means and a contact portion including a plurality of contact terminals to establish electrical connection with terminals of the tested device are provided at a side opposite in direction to the second direction with respect to the first locating means, and wherein there is provided
second locating means for urging the tested device in a direction opposite to the second direction from a side along the second direction with respect to the first locating means to fix a position of the ceiling plane of the tested device to a predetermined ceiling position.

4. The test socket according to claim 3, wherein
the contact terminals are arranged in a matrix in the contact portion.
